(19) United States
(12) Patent Application Publication
(10) Pub. No.: US 2026/0080326 A1
(43) Pub. Date: Mar. 19, 2026

(54) METHODS AND APPARATUS FOR DISTRIBUTING GENERATIVE ARTIFICIAL INTELLIGENCE TASKS TO ENTERPRISE HARDWARE

(71) Applicant: Intel Corporation, Santa Clara, CA (US)

(72) Inventors: Xia Zhu, Portland, OR (US); Elmoustapha Ould-Ahmed-Vall, Chandler, AZ (US); Jianfang Zhu, Washougal, WA (US)

(73) Assignee: Intel Corporation, Santa Clara, CA (US)

(21) Appl. No.: 19/394,125

(22) Filed: Nov. 19, 2025

Related U.S. Application Data
(60) Provisional application No. 63/854,424, filed on Jul. 30, 2025.

(51) Int. Cl. G06Q 10/0631

(52) U.S. Cl. CPC G06Q 10/063112

(57) ABSTRACT

Methods and apparatus disclosed herein introduce a comprehensive framework for distributing generative-AI workloads across diverse enterprise hardware. Multiple routing strategies disclosed herein include user-controlled, algorithm-controlled, hybrid, and dual-path routing with feedback to accommodate varying user expertise and resource availability. The routing logic is detailed for Question Answering (QA) tasks, Retrieval-Augmented Generation (RAG)-based tasks (e.g., document parsing and retrieval), and agent tasks, including evaluation of resource availability, model complexity, and content characteristics. User feedback can be obtained to continuously refine routing decisions through Large Language Model (LLM) based and traditional machine learning models. Methods and apparatus disclosed herein initiate routing decisions to maintain cost-efficiency, performance optimization, and accuracy across heterogeneous computing environments.

### RELATED APPLICATION

This patent claims the benefit of U.S. Provisional Patent Application No. 63/854,424, filed Jul. 30, 2025, entitled “System, Method and Apparatus for Distributing Generative AI Tasks to Different Hardware.” The entire disclosure of U.S. Provisional Patent Application No. 63/854,424 is hereby incorporated by reference in its entirety.

### BACKGROUND

Generative artificial intelligence (GenAI) creates original content (e.g., text, images, video, audio, software code, etc.) in response to a user prompt and/or request. GenAI relies on foundation models (e.g., Large Language Models (LLMs)) for augmented tasks (e.g., enhancing or augmenting human capabilities), transactional tasks (e.g., performing actions based on predefined rules or user inputs), and autonomous tasks (e.g., performing complex operations with minimal human intervention).

### BRIEF DESCRIPTION OF THE DRAWINGS

FIG. 1 is a block diagram of an example implementation of task performer circuitry constructed in accordance with teachings of this disclosure to distribute a generative artificial intelligence (GenAI) task across local and/or remote hardware resources.

FIG. 2 is a flowchart representative of example machine-readable instructions and/or example operations that may be executed, instantiated, and/or performed by example programmable circuitry to implement the example task performer circuitry of FIG. 1.

FIG. 3 is a flowchart representative of example machine-readable instructions and/or example operations that may be executed, instantiated, and/or performed by the example task performer circuitry of FIG. 1 to initiate algorithm-controlled routing.

FIG. 4 is a flowchart representative of example machine-readable instructions and/or example operations that may be executed, instantiated, and/or performed by the example task performer circuitry of FIG. 1 to perform routing for a question answering (QA) task.

FIG. 5 is a flowchart representative of example machine-readable instructions and/or example operations that may be executed, instantiated, and/or performed by the example task performer circuitry of FIG. 1 to perform routing for a Retrieval-Augmented Generation (RAG) task.

FIG. 6 is a flowchart representative of example machine-readable instructions and/or example operations that may be executed, instantiated, and/or performed by the example task performer circuitry of FIG. 1 to perform RAG-based retrieval.

FIG. 7 is a flowchart representative of example machine-readable instructions and/or example operations that may be executed, instantiated, and/or performed by the example task performer circuitry of FIG. 1 to perform routing for an agent task.

FIG. 8 is a flowchart representative of example machine-readable instructions and/or example operations that may be executed, instantiated, and/or performed by the example task performer circuitry of FIG. 1 to initiate hybrid routing.

FIG. 9 is a flowchart representative of example machine-readable instructions and/or example operations that may be executed, instantiated, and/or performed by the example task performer circuitry of FIG. 1 to initiate dual path routing with user feedback.

FIG. 10 is a block diagram of an example processing platform including programmable circuitry structured to execute, instantiate, and/or perform the example machine readable instructions and/or perform the example operations of FIGS. 2-9 to implement the example task performer circuitry of FIG. 1.

FIG. 11 is a block diagram of an example implementation of the programmable circuitry of FIG. 10.

FIG. 12 is a block diagram of another example implementation of the programmable circuitry of FIG. 10.

FIG. 13 is a block diagram of an example software/firmware/instructions distribution platform (e.g., one or more servers) to distribute software, instructions, and/or firmware (e.g., corresponding to the example machine readable instructions of FIGS. 2-9) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

In general, the same reference numbers will be used throughout the drawing(s) and accompanying written description to refer to the same or like parts. The figures are not necessarily to scale.

### DETAILED DESCRIPTION

GenAI-based tasks are performed by foundation models (e.g., large language models (LLMs)) to process user requests (e.g., human or agent-based) for a variety of applications (e.g., improving customer interactions in chat and search-based applications, synthesizing summaries from unstructured data, assisting with repetitive tasks, etc.). Task routing in GenAI allows for the selection of an AI model that is most suitable to perform the task based on desired efficiency, accuracy, and/or cost-effectiveness. The use of generative models as part of GenAI adds factors that can affect performance. Such factors can include heavy Video Random Access Memory (VRAM) usage as part of a dedicated memory on a Graphics Processing Unit (GPU) for GenAI model training and inference, with insufficient VRAM representing a bottleneck in AI performance.

Additionally, sequential token generation (e.g., associated with autoregressive loops for predicting the next token in a sequence of all preceding tokens) introduces increased latency and computational overhead (e.g., consuming significant computational resources that increase with the sequence length due to an expanding Key-Value (KV) cache). Hidden state preservation also contributes to computational overhead, since running GenAI models involves preserving internal representations that encode information about previous inputs and generated tokens (e.g., to maintain context across successive requests). As such, even small alterations in hardware, batching logic, or runtime implementation can result in latency spikes and reduced performance during load surges.

GenAI generates an output based on a user query, such that the user can view the resulting output through a chatbot or Application Programming Interface (API), with the quality of the inference phase determining the quality of the user experience and/or perceived performance. Given the iterative process of generative systems, generative inference demands computational resources to achieve a desired level of latency, throughput, and memory management. Inference represents an operational cost that scales directly with usage, each user request generating high demands for GPU time and VRAM utilization that can become unsustainable with increasing loads (e.g., long contexts, large batches, etc.). Hardware infrastructure used for GenAI model inference guides GenAI model performance based on GPU selection (e.g., for handling KV cache updates, state management, weight access, etc.) and bandwidth (e.g., accelerators with high-speed interconnects provide greater stability under load as compared to Peripheral Component Interconnect Express (PCIe)-based GPUs). Other factors affecting throughput include compute precision (e.g., FP16, INT4, etc.), on-chip cache size, and/or tensor core number. Shared environments also require session management to prevent uneven loads across multiple users (e.g., enforcing limits on input size, monitoring GPU allocation, and capping session durations). GenAI tasks can be routed to various enterprise-based hardware resources (e.g., AI personal computers (PCs), edge servers, workstations, server clusters, etc.), but identification of which hardware resources to route GenAI tasks to for improved efficiency and reduced total cost remains a challenge.

Methods and apparatus disclosed herein efficiently distribute GenAI tasks to different enterprise hardware for improved accuracy of task execution while reducing the total cost of ownership. In examples disclosed herein, an enterprise environment featuring a diverse array of hardware configurations to accommodate various computing needs can be used for GenAI tasks. Methods and apparatus disclosed herein route GenAI tasks to different local and/or remote hardware resources for efficient resource allocation and scalability, catering to both individual and collective computing demands within an organization. In examples disclosed herein, GenAI task routing can be user-controlled routing, algorithm-controlled routing, hybrid routing, and/or dual path routing with user feedback. Additionally, algorithm-controlled routing can include routing for Question Answering (QA) tasks, routing for Retrieval Augmented Generation (RAG) tasks, and/or routing for agent tasks.

In examples disclosed herein, routing for QA tasks includes identifying availability of local and/or remote services, including local and/or remote models for performing the task. In examples disclosed herein, routing for RAG-based tasks includes identifying document(s) with relevant context at a local and/or remote service and performing document parsing at the local and/or remote service based on the user query. In examples disclosed herein, performing RAG-based retrieval includes determining whether a similarity score between the user query and locally retrieved contextual information exceeds a given threshold as part of identifying whether to route the user query and context to a local model or to a QA routing pipeline. For example, when the similarity score exceeds the threshold, the query and context are routed to a local model for further processing. In examples disclosed herein, performing routing for an agent task includes identifying whether to route a request to a local or remote agent based on availability. In examples disclosed herein, hybrid routing includes allowing the user to provide their preferred routing pathway for a given user request, followed by initiation of algorithm-controlled routing when the user requests to initiate algorithmic guidance on more complicated tasks. In examples disclosed herein, dual path user query routing with user feedback includes sending the user query to both remote and local services simultaneously and prompting the user to evaluate the output from the remote and local services (e.g., based on a user feedback score) as part of fine-tuning the routing algorithm for improved accuracy of task execution.

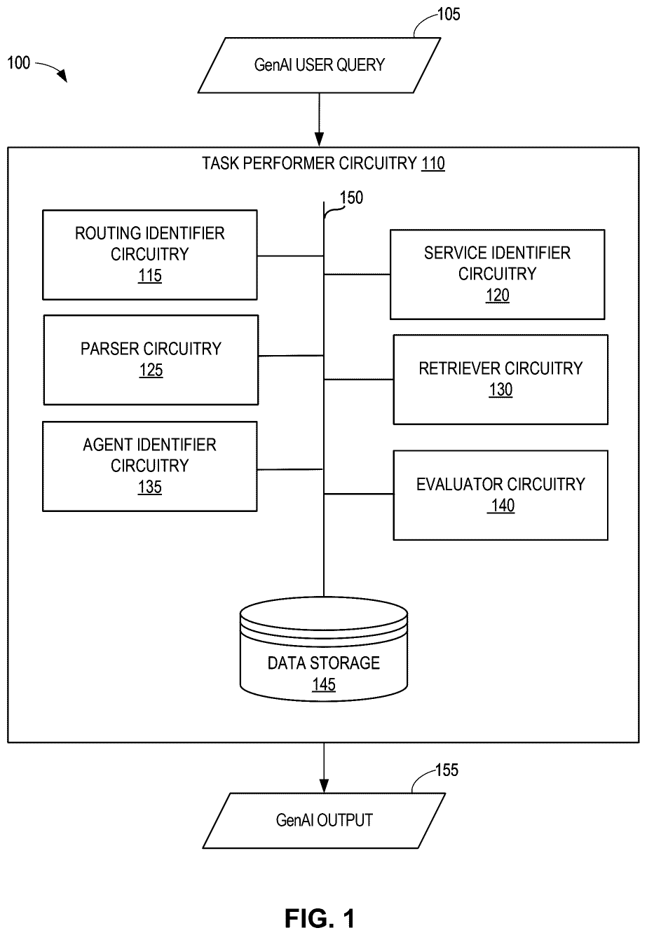

FIG. 1 is a block diagram 100 of an example implementation of task performer circuitry 110 constructed in accordance with teachings of this disclosure to distribute a generative artificial intelligence (GenAI) task across local and/or remote hardware resources. The task performer circuitry 110 of FIG. 1 may be instantiated (e.g., creating an instance of, bring into being for any length of time, materialize, implement, etc.) by programmable circuitry. For example, programmable circuitry may be implemented by a Central Processing Unit (CPU) executing first instructions, a field programmable gate array, a programmable logic device (PLD), a generic array logic (GAL) device, a programmable array logic (PAL) device, a complex programmable logic device (CPLD), a simple programmable logic device (SPLD), a microcontroller (MCU), a programmable system on chip (PSoC), etc. Additionally or alternatively, the task performer circuitry 110 of FIG. 1 may be instantiated (e.g., creating an instance of, bring into being for any length of time, materialize, implement, etc.) by (i) an Application Specific Integrated Circuit (ASIC) and/or (ii) a Field Programmable Gate Array (FPGA) (e.g., another form of programmable circuitry) structured and/or configured in response to execution of second instructions to perform operations corresponding to the first instructions. It should be understood that some or all of the circuitry of FIG. 1 may, thus, be instantiated at the same or different times. Some or all of the circuitry of FIG. 1 may be instantiated, for example, in one or more threads executing concurrently on hardware and/or in series on hardware. Moreover, in some examples, some or all of the circuitry of FIG. 1 may be implemented by microprocessor circuitry executing instructions and/or FPGA circuitry performing operations to implement one or more virtual machines and/or containers.

In the example of FIG. 1, the task performer circuitry 110 includes example routing identifier circuitry 115, example service identifier circuitry 120, example parser circuitry 125, example retriever circuitry 130, example agent identifier circuitry 135, example evaluator circuitry 140, and data storage 145. The routing identifier circuitry 115, the service identifier circuitry 120, the parser circuitry 125, the retriever circuitry 130, the agent identifier circuitry 135, the evaluator circuitry 140, and the data storage 145 are in communication via an example bus 150.

The routing identifier circuitry 115 receives an example GenAI-based user query 105. In examples disclosed herein, the user query 105 represents a question and/or request submitted by a user for processing by an AI model to provide a detailed answer represented by an example GenAI output 155 (e.g., including generation of new content, code, completion of complex data analysis tasks, etc.). In examples disclosed herein, the routing identifier circuitry 115 routes the GenAI task to the most appropriate enterprise hardware resource(s) for execution (e.g., based on a preferred level of accuracy of the GenAI output 155, reduced total cost of ownership (TCO), etc.). In examples disclosed herein, TCO includes the cost of generating the GenAI output 155, including the cost of tokens (e.g., output tokens being more expensive given that generating a response is more computationally intensive than reading a prompt). In some examples, TCO depends on the use of local GenAI services and/or resources versus remote GenAI services and/or resources. While local resources can include initial costs associated with purchasing and hardware installation (e.g., servers, GPUs, software licenses, etc.), there are lower variable costs per token. Remote resources (e.g., cloud-based services), however, include variable costs based on usage (e.g., token consumption, data transfer, subscription fees, etc.). In some examples, high-volume predictable workloads can have a lower TCO in the long term when using a local resource despite high initial investments, while low-volume unpredictable workloads can be more cost-effective when using a remote service due to lower initial costs.

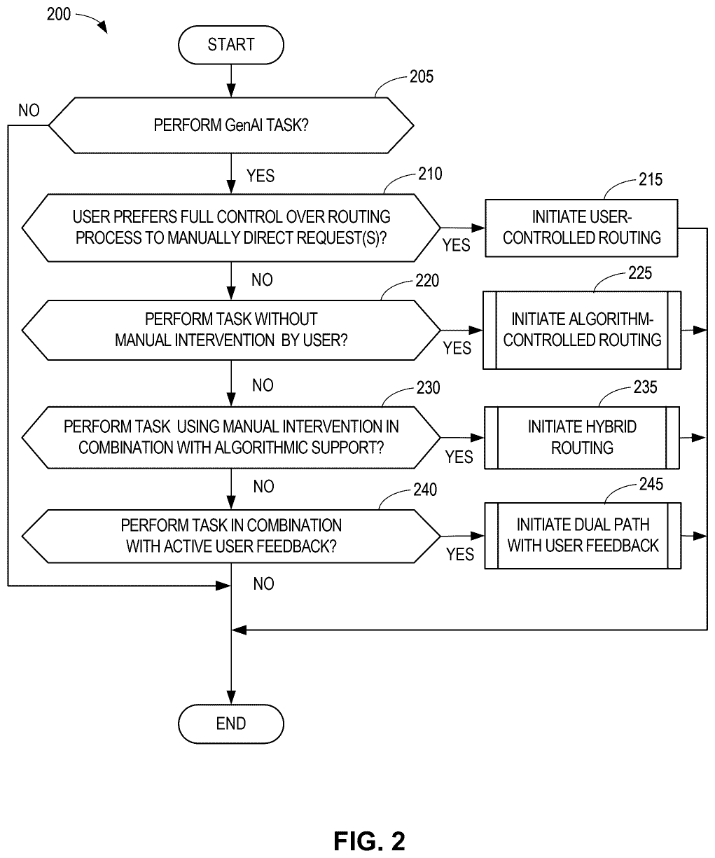

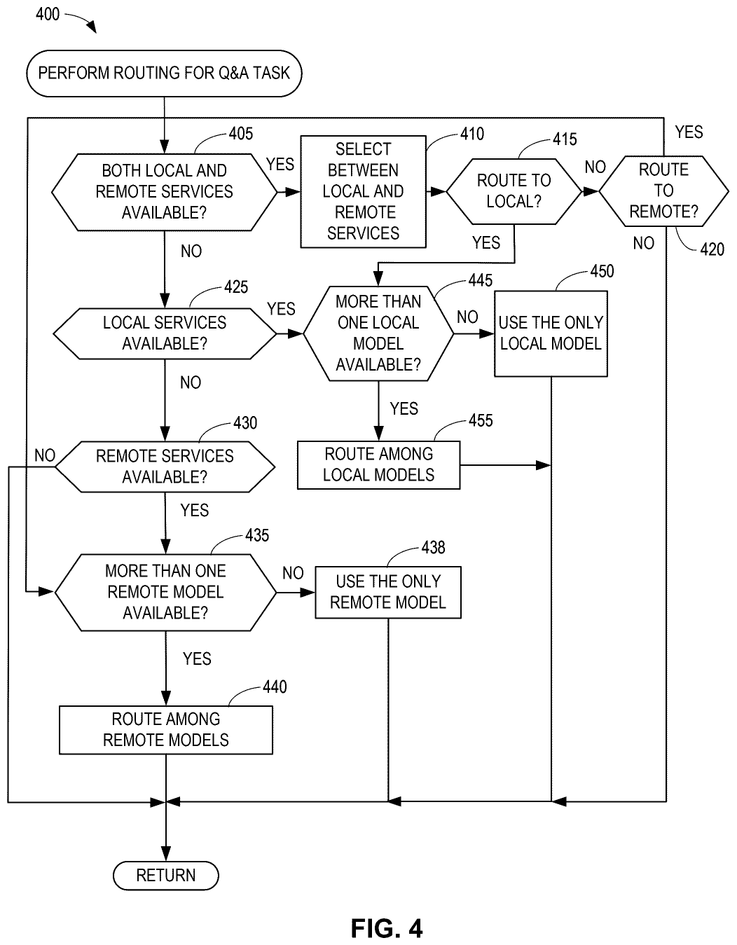

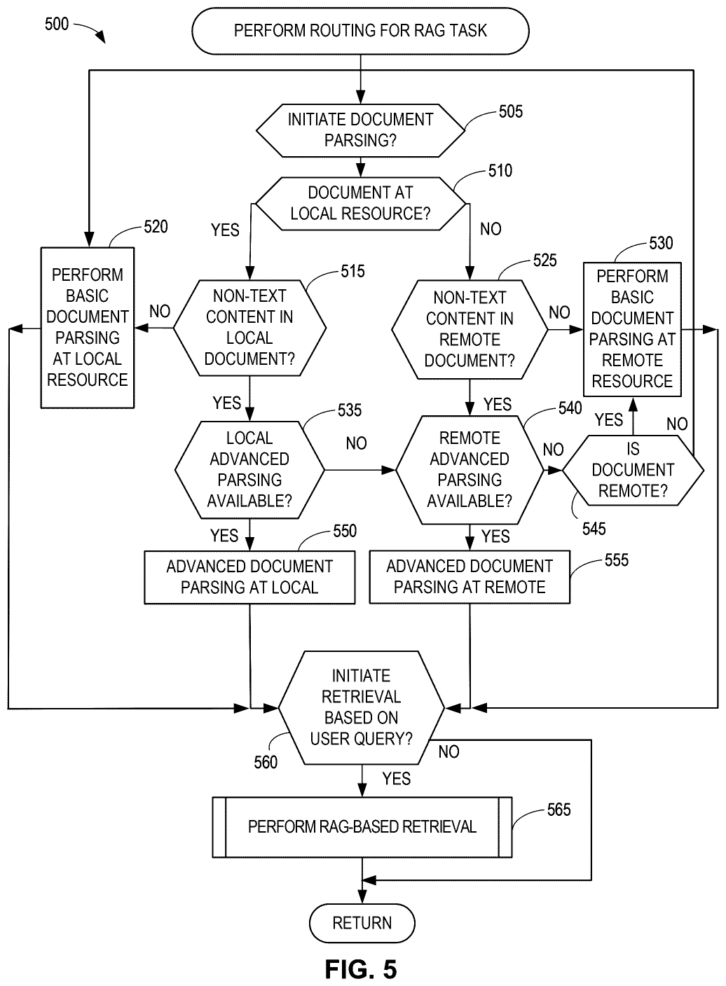

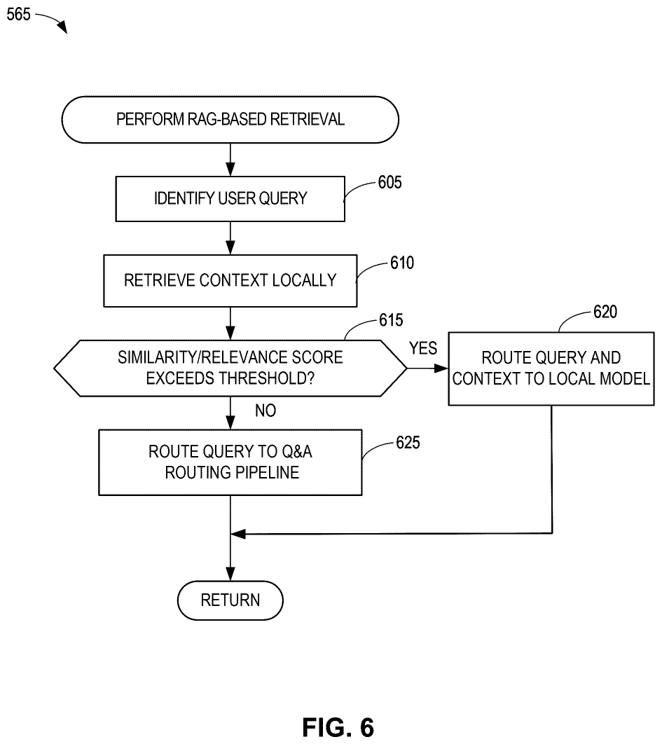

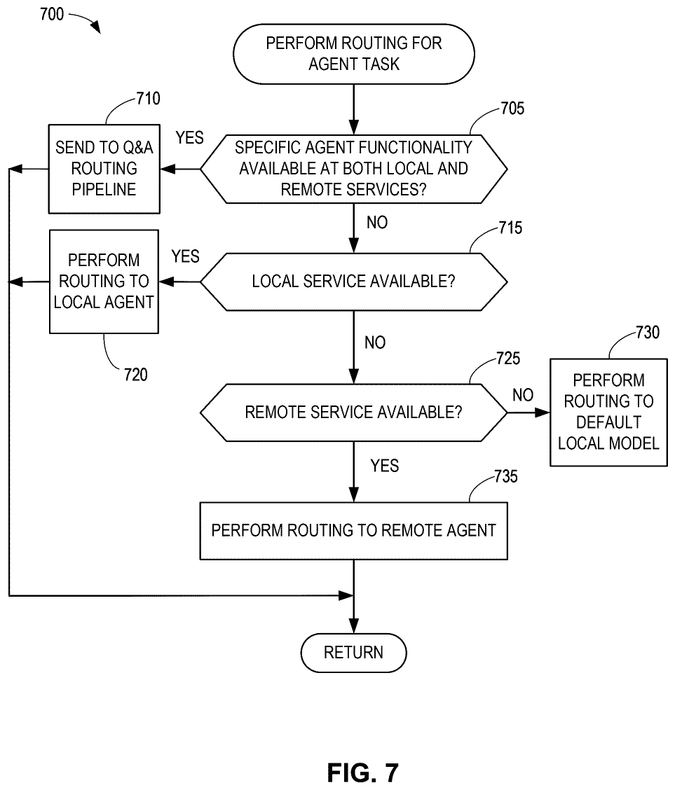

In examples disclosed herein, the routing identifier circuitry 115 determines whether to initiate user-controlled routing, algorithm-controlled routing, hybrid routing, or dual path routing of the user query 105. As described in more detail in connection with FIG. 2, the routing identifier circuitry 115 initiates (1) algorithm-controlled routing to perform a task without manual intervention by a user, (2) hybrid routing when performing a task with manual intervention in combination with algorithmic support, (3) dual path routing when performing a task in combination with active user feedback, or (4) user-controlled routing when a user indicates preference for having full control over the routing process. In examples disclosed herein, the routing identifier circuitry 115 can perform routing for a Question Answering (QA) task, as described in more detail in connection with FIG. 4, a Retrieval Augmented Generation (RAG) task, as described in more detail in connection with FIGS. 5-6, or an agent task, as described in more detail in connection with FIG. 7.

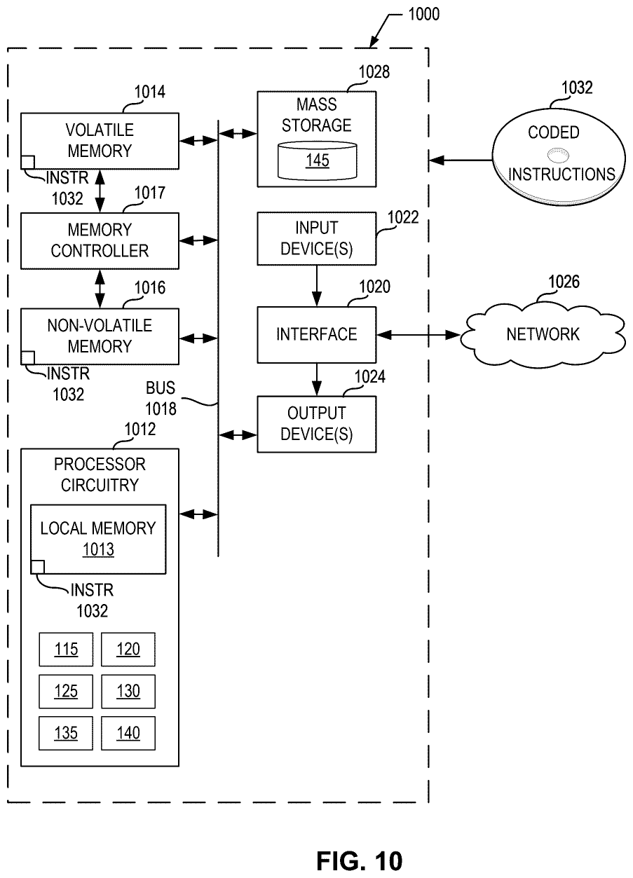

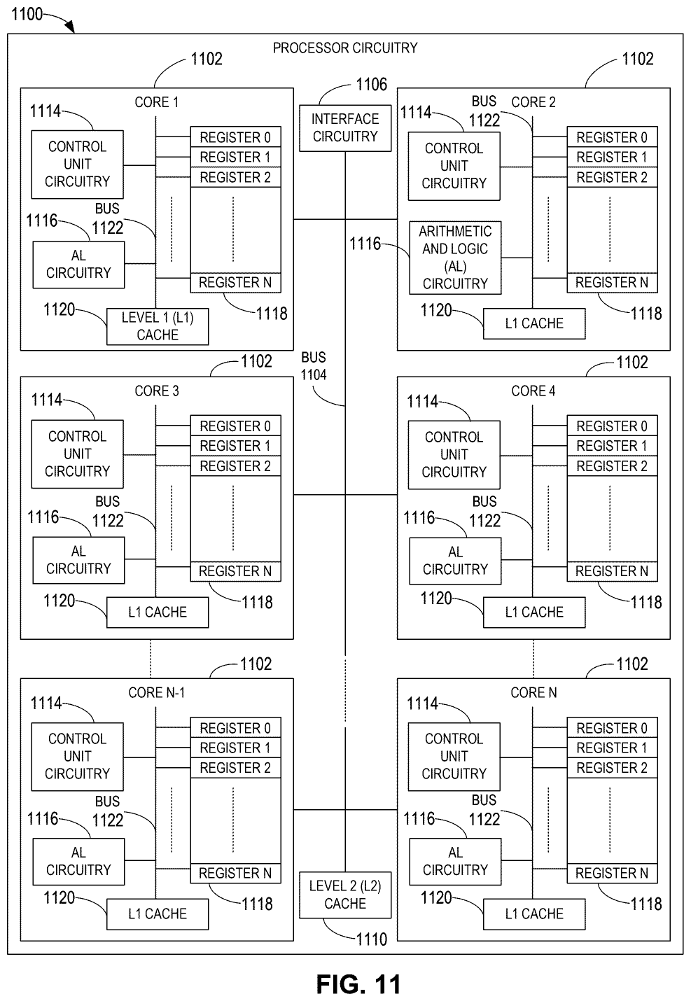

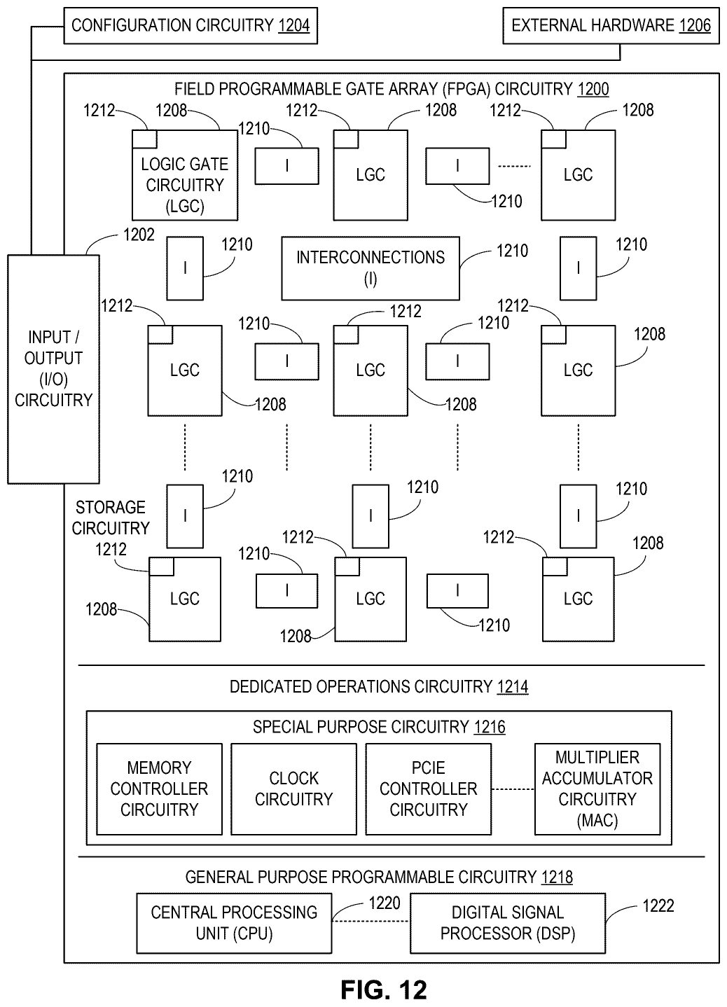

In some examples, the apparatus includes means for routing a GenAI task. For example, the means for routing the GenAI task may be implemented by routing identifier circuitry 115. In some examples, the routing identifier circuitry 115 may be instantiated by programmable circuitry such as the example programmable circuitry 1012 of FIG. 10. For instance, the routing identifier circuitry 115 may be instantiated by the example microprocessor 1100 of FIG. 11 executing machine executable instructions such as those implemented by at least block(s) 215, 225, 235, 245 of FIG. 2. In some examples, the routing identifier circuitry 115 may be instantiated by hardware logic circuitry, which may be implemented by an ASIC, XPU, or the FPGA circuitry 1200 of FIG. 12 structured to perform operations corresponding to the machine readable instructions. Additionally or alternatively, the routing identifier circuitry 115 may be instantiated by any other combination of hardware, software, and/or firmware. For example, the routing identifier circuitry 115 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

The service identifier circuitry 120 identifies the presence of local and/or remote services as part of the QA task routing. For example, the service identifier circuitry 120 selects between local and remote services as part of determining whether to route the QA task to a local service or a remote service. In some examples, the service identifier circuitry 120 identifies the local service (e.g., software and/or tools allowing the user to run GenAI models entirely on their own hardware without relying on cloud servers) and/or the remote service (e.g., cloud-based platform or Application Programming Interface (API) that allows users access to powerful GenAI models without needing to host or manage the underlying infrastructure) based on the desired accuracy and/or latency of task execution. For example, remote services are designed to handle high demands, allowing for fast response times and scaling of resources, with access to large, pre-trained foundation models that can perform a wide range of general tasks. On the other hand, local resources allow for all data processing to happen locally on the user machine with potential for offline access, with full user control over models and their configurations. As such, selection of the local service versus the remote service can depend on the type of user query (e.g., level of complexity, time of completion, context, etc.).

In some examples, the apparatus includes means for identifying availability of a local hardware resource or a remote hardware resource. For example, the means for identifying availability of a local hardware resource or a remote hardware resource may be implemented by service identifier circuitry 120. In some examples, the service identifier circuitry 120 may be instantiated by programmable circuitry such as the example programmable circuitry 1012 of FIG. 10. For instance, the service identifier circuitry 120 may be instantiated by the example microprocessor 1100 of FIG. 11 executing machine executable instructions such as those implemented by at least block(s) 405, 425, 430 of FIG. 4. In some examples, the service identifier circuitry 120 may be instantiated by hardware logic circuitry, which may be implemented by an ASIC, XPU, or the FPGA circuitry 1200 of FIG. 12 structured to perform operations corresponding to the machine readable instructions. Additionally or alternatively, the service identifier circuitry 120 may be instantiated by any other combination of hardware, software, and/or firmware. For example, the service identifier circuitry 120 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

The parser circuitry 125 initiates document parsing as part of Retrieval Augmented Generation (RAG). As described in more detail in connection with FIGS. 5-6, RAG is a GenAI framework that improves GenAI by allowing natural language processing machine learning model engines (e.g., LLMs) to integrate private enterprise data with publicly available information. Reliance on the use of GenAI to provide responses to user-based queries requires accuracy. RAG models allow for the combination of retrieval-based methods with generative models to obtain contextually accurate and semantically rich outputs. RAG can search, query, and provision relevant data associated with a user-based query to generate an enriched, contextual prompt that is provided to the LLM for further processing. In examples disclosed herein, the parser circuitry 125 performs document parsing at a local resource or a remote resource, based on the availability of the document at each location. In some examples, the parser circuitry 125 identifies the presence of non-text content in the local and/or remote document (e.g., embedded graphics, tables, mathematical equations, handwritten annotations, etc.). In some examples, the parser circuitry 125 performs advanced parsing based on the presence of the non-text content. The parser circuitry 125 can extract text and/or any other type of information from documents, while also preserving structure, context, and relationship with data that is highlighted by the specific document(s).

In some examples, the apparatus includes means for parsing. For example, the means for parsing may be implemented by parser circuitry 125. In some examples, the parser circuitry 125 may be instantiated by programmable circuitry such as the example programmable circuitry 1012 of FIG. 10. For instance, the parser circuitry 125 may be instantiated by the example microprocessor 1100 of FIG. 11 executing machine executable instructions such as those implemented by at least block(s) 505, 520, 530, 550, 555 of FIG. 5. In some examples, the parser circuitry 125 may be instantiated by hardware logic circuitry, which may be implemented by an ASIC, XPU, or the FPGA circuitry 1200 of FIG. 12 structured to perform operations corresponding to the machine readable instructions. Additionally or alternatively, the parser circuitry 125 may be instantiated by any other combination of hardware, software, and/or firmware. For example, the parser circuitry 125 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

The retriever circuitry 130 retrieves context based on the user query as part of searching for information that is relevant to the GenAI-based user query 105 of FIG. 1. In some examples, the retriever circuitry 130 determines a type of retrieval to perform based on the nature of the dataset, the complexity of the received user query, and/or the level of contextual understanding desired in the responses to the user query. For example, the retriever circuitry 130 can include the use of a vector database, a graph database, or a regular Structured Query Language (SQL) database. In examples disclosed herein, the vector database is used when queries are embedded for generating dense vector embeddings and/or sparse embeddings, such that the retriever circuitry 130 performs a search based on term frequency (e.g., Term Frequency-Inverse Document Frequency (TF-IDF)) and/or semantic similarity. However, any other type of database and/or method of retrieval can be used to identify relevant candidate context. For example, vector databases can be used for partitioning indexing data using LLM-encoded vectors to obtain semantically similar vector retrieval. In some examples, graph databases can be used to develop a database from extracted entity relationships in the text, introducing concise retrievals (e.g., by requiring exact query matching). In examples disclosed herein, the retriever circuitry 130 determines whether to route the query and context to a local model or to the QA routing pipeline based on a similarity or relevance score between the query and available context. If the score of the retrieved context surpasses a predefined threshold, both the query and the most relevant context are directed to the local model for further processing, as described in more detail in connection with FIG. 6.

In some examples, the apparatus includes means for retrieving. For example, the means for retrieving may be implemented by retriever circuitry 130. In some examples, the retriever circuitry 130 may be instantiated by programmable circuitry such as the example programmable circuitry 1012 of FIG. 10. For instance, the retriever circuitry 130 may be instantiated by the example microprocessor 1100 of FIG. 11 executing machine executable instructions such as those implemented by at least block(s) 610 of FIG. 6. In some examples, the retriever circuitry 130 may be instantiated by hardware logic circuitry, which may be implemented by an ASIC, XPU, or the FPGA circuitry 1200 of FIG. 12 structured to perform operations corresponding to the machine readable instructions. Additionally or alternatively, the retriever circuitry 130 may be instantiated by any other combination of hardware, software, and/or firmware. For example, the retriever circuitry 130 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

The agent identifier circuitry 135 determines whether to use a specific agent functionality at a remote service or a local service, as described in more detail in connection with FIG. 7. Agent task routing can be more flexible, dynamically selecting between different routing pathways. In some examples, the agent identifier circuitry 135 selects among different pipelines (e.g., QA routing pipeline, RAG-based pipeline, etc.). The agent identifier circuitry 135 can use an LLM to analyze the user query as part of determining the most appropriate task routing pathway. For example, while RAG-based routing can be appropriate for simpler, well-defined tasks where a single retrieval and generation process is sufficient, agent task routing can be used for more complex scenarios requiring multi-step reasoning, complex decision-making, or interaction with multiple tools and/or data sources.

In some examples, the apparatus includes means for routing to an agent. For example, the means for routing to an agent may be implemented by agent identifier circuitry 135. In some examples, the agent identifier circuitry 135 may be instantiated by programmable circuitry such as the example programmable circuitry 1012 of FIG. 10. For instance, the agent identifier circuitry 135 may be instantiated by the example microprocessor 1100 of FIG. 11 executing machine executable instructions such as those implemented by at least block(s) 720, 735 of FIG. 7. In some examples, the agent identifier circuitry 135 may be instantiated by hardware logic circuitry, which may be implemented by an ASIC, XPU, or the FPGA circuitry 1200 of FIG. 12 structured to perform operations corresponding to the machine readable instructions. Additionally or alternatively, the agent identifier circuitry 135 may be instantiated by any other combination of hardware, software, and/or firmware. For example, the agent identifier circuitry 135 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

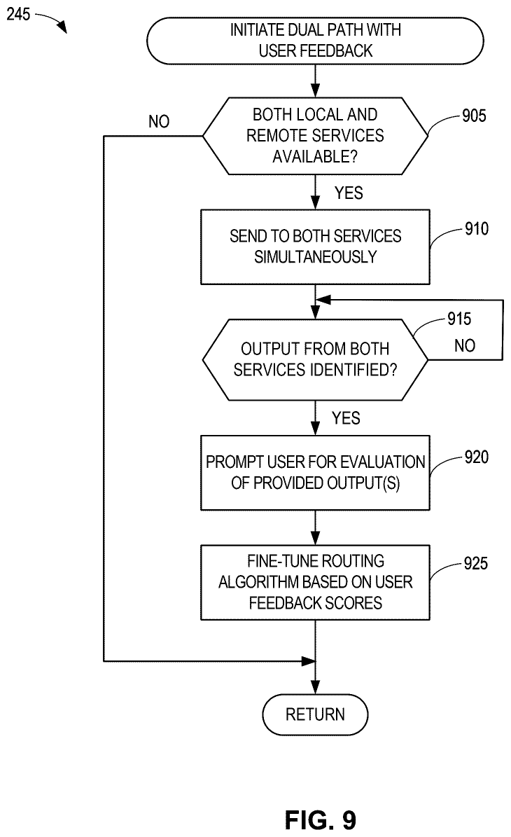

The evaluator circuitry 140 prompts user(s) to evaluate output(s) from local and/or remote services as part of performing fine-tuning of routing algorithms based on user feedback scores. As described in more detail in connection with FIG. 9, the evaluator circuitry 140 identifies user feedback scores associated with the level of accuracy of a given model. The user feedback scores can be leveraged to predict routing based on LLM and/or non-LLM methods. For LLM-based approaches, the user's query and instructions are input into the LLM, generating a routing prediction based on the input, while non-LLM-based models (e.g., transformer-based classifier models, simpler matrix factorization types of recommendation models, etc.) can be trained to predict routing between local and remote systems.

In some examples, the apparatus includes means for causing generation of an output. For example, the means for causing generation of an output may be implemented by evaluator circuitry 140. In some examples, the evaluator circuitry 140 may be instantiated by programmable circuitry such as the example programmable circuitry 1012 of FIG. 10. For instance, the evaluator circuitry 140 may be instantiated by the example microprocessor 1100 of FIG. 11 executing machine executable instructions such as those implemented by at least block(s) 920, 925 of FIG. 9. In some examples, the evaluator circuitry 140 may be instantiated by hardware logic circuitry, which may be implemented by an ASIC, XPU, or the FPGA circuitry 1200 of FIG. 12 structured to perform operations corresponding to the machine readable instructions. Additionally or alternatively, the evaluator circuitry 140 may be instantiated by any other combination of hardware, software, and/or firmware. For example, the evaluator circuitry 140 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

The data storage 145 can be used to store any information associated with the routing identifier circuitry 115, the service identifier circuitry 120, the parser circuitry 125, the retriever circuitry 130, the agent identifier circuitry 135, and the evaluator circuitry 140. The data storage 145 of the illustrated example of FIG. 1 can be implemented by any memory, storage device and/or storage disc for storing data such as flash memory, magnetic media, optical media, etc. Furthermore, the data stored in the data storage 145 can be in any data format such as binary data, comma delimited data, tab delimited data, structured query language (SQL) structures, image data, etc.

While an example manner of implementing the task performer circuitry 110 is illustrated in FIG. 1, one or more of the elements, processes and/or devices illustrated in FIG. 1 may be combined, divided, re-arranged, omitted, eliminated and/or implemented in any other way. Further, the example routing identifier circuitry 115, the example service identifier circuitry 120, the example parser circuitry 135, the example evaluator circuitry 140, and/or, more generally, the example task performer circuitry 110 of FIG. 1 may be implemented by hardware, software, firmware and/or any combination of hardware, software and/or firmware. Thus, for example, the routing identifier circuitry 115, the service identifier circuitry 120, the parser circuitry 135, the evaluator circuitry 140, and/or, more generally, the task performer circuitry 110 of FIG. 1 could be implemented by programmable circuitry, processor circuitry, analog circuit(s), digital circuit(s), logic circuit(s), programmable processor(s), programmable microcontroller(s), graphics processing unit(s) (GPU(s)), digital signal processor(s) (DSP(s), ASIC(s)), programmable logic device(s) (PLD(s)), vision processing units (VPUs), and/or field programmable logic device(s) (FPLD(s)) such as FPGAs in combination with machine readable instructions (e.g., firmware or software). Further still, the task performer circuitry 110 of FIG. 1 may include one or more elements, processes, and/or devices in addition to, or instead of, those illustrated in FIG. 1, and/or may include more than one of any or all of the illustrated elements, processes and devices.

Flowcharts representative of example machine readable instructions, which may be executed by programmable circuitry to implement and/or instantiate the task performer circuitry 110 of FIG. 1 and/or representative of example operations which may be performed by programmable circuitry to implement and/or instantiate the task performer circuitry 110 of FIG. 1, are shown in FIGS. 2-9. The machine readable instructions may be one or more executable programs or portion(s) of one or more executable programs for execution by programmable circuitry, such as the programmable circuitry 1012 shown in the example processor platform 1000 discussed below in connection with FIG. 10 and/or may be one or more function(s) or portion(s) of functions to be performed by the example programmable circuitry (e.g., an FPGA) discussed below in connection with FIGS. 11 and/or 12. In some examples, the machine readable instructions cause an operation, a task, etc., to be carried out and/or performed in an automated manner in the real world. As used herein, “automated” means without human involvement.

The program may be embodied in instructions (e.g., software and/or firmware) stored on one or more non-transitory computer readable and/or machine readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer readable and/or machine readable medium may program and/or be executed by programmable circuitry located in one or more hardware devices, but the entire program and/or parts thereof could alternatively be executed and/or instantiated by one or more hardware devices other than the programmable circuitry and/or embodied in dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer readable storage medium may include one or more mediums. Further, although the example program is described with reference to the flowcharts illustrated in FIGS. 2-9, many other methods of implementing the task performer circuitry 110 of FIG. 1 may alternatively be used. For example, the order of execution of the blocks of the flowchart(s) may be changed, and/or some of the blocks described may be changed, eliminated, or combined. Additionally or alternatively, any or all of the blocks of the flow chart may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, etc.)). As used herein, programmable circuitry includes any type(s) of circuitry that may be programmed to perform a desired function such as, for example, a CPU, a GPU, a VPU, and/or an FPGA. The programmable circuitry may include one or more CPUs, one or more GPUs, one or more VPUs, and/or one or more FPGAs located in the same package (e.g., the same integrated circuit (IC) package or in two or more separate housings), one or more CPUs, GPUs, VPUs, and/or one or more FPGAs in a single machine, multiple CPUs, GPUs, VPUs, and/or FPGAs distributed across multiple servers of a server rack, and/or multiple CPUs, GPUs, VPUs, and/or FPGAs distributed across one or more server racks. Additionally or alternatively, programmable circuitry may include a programmable logic device (PLD), a generic array logic (GAL) device, a programmable array logic (PAL) device, a complex programmable logic device (CPLD), a simple programmable logic device (SPLD), a microcontroller (MCU), a programmable system on chip (PSoC), etc., and/or any combination(s) thereof in any of the contexts explained above.

The machine readable instructions described herein may be stored in one or more of a compressed format, an encrypted format, a fragmented format, a compiled format, an executable format, a packaged format, etc. Machine readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine executable instructions. For example, the machine readable instructions may be fragmented and stored on one or more storage devices, disks and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of computer-executable and/or machine executable instructions that implement one or more functions and/or operations that may together form a program such as that described herein.

In another example, the machine readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable, computer readable and/or machine readable media, as used herein, may include instructions and/or program(s) regardless of the particular format or state of the machine readable instructions and/or program(s).

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example operations of FIGS. 2-9 may be implemented using executable instructions (e.g., computer readable and/or machine readable instructions) stored on one or more non-transitory computer readable and/or machine readable media. As used herein, the terms non-transitory computer readable medium, non-transitory computer readable storage medium, non-transitory machine readable medium, and/or non-transitory machine readable storage medium are expressly defined to include any type of computer readable storage device and/or storage disk and to exclude propagating signals and to exclude transmission media. Examples of such non-transitory computer readable medium, non-transitory computer readable storage medium, non-transitory machine readable medium, and/or non-transitory machine readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer readable storage device” and “non-transitory machine readable storage device” are defined to include any physical (mechanical, magnetic and/or electrical) hardware to retain information for a time period, but to exclude propagating signals and to exclude transmission media. Examples of non-transitory computer readable storage devices and/or non-transitory machine readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer-readable instructions, machine-readable instructions, etc.

FIG. 2 is a flowchart representative of example machine-readable instructions and/or example operations 200 that may be executed, instantiated, and/or performed by example programmable circuitry to implement the example task performer circuitry 110 of FIG. 1. The machine-readable instructions and/or the operations 200 of FIG. 7 begin at block 205, at which the routing identifier circuitry 115 determines whether to perform a GenAI task. The GenAI task can be any task associated with a user query (e.g., GenAI user query 105 of FIG. 1), targeting the creation of new, original content and/or automating complex, data-driven processes. In examples disclosed herein, the user can represent a human or a non-human agent. In the example of FIG. 2, the routing identifier circuitry 115 determines the type of routing to initiate based on whether the user prefers to retain full control over the routing process to manually direct requests, at block 210. If the user prefers full control over the routing process, the routing identifier circuitry 115 initiates user-controlled routing, at block 215. In examples disclosed herein, user-controlled routing is designed for experienced users who are well-versed in both generative AI tasks and hardware. These users prefer full control over the routing process, allowing them to manually direct their requests based on their deep understanding of the system.

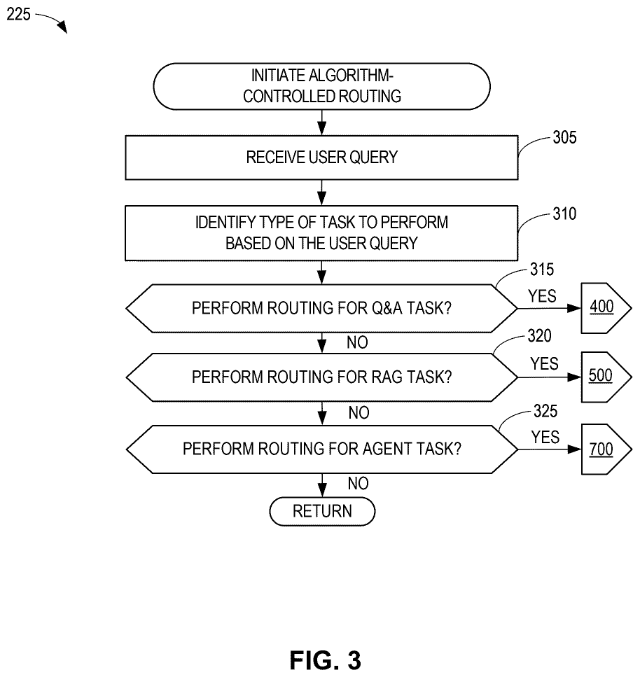

If the task is performed without manual intervention by the user, at block 220, the routing identifier circuitry 115 initiates algorithm-controlled routing, at block 225, as described in more detail in connection with FIG. 3. In examples disclosed herein, algorithm-controlled routing is tailored for users who may have limited knowledge of generative AI tasks or hardware specifics. In this mode, the routing decisions are handled automatically by advanced algorithms, ensuring efficient and optimized performance without manual intervention. In examples disclosed herein, algorithm-controlled routing is designed to accommodate different types of generative AI tasks (e.g., Question Answering tasks, Retrieval Augmented Generation (RAG) tasks, etc.), ensuring that the routing system is versatile and adaptable to various use cases.

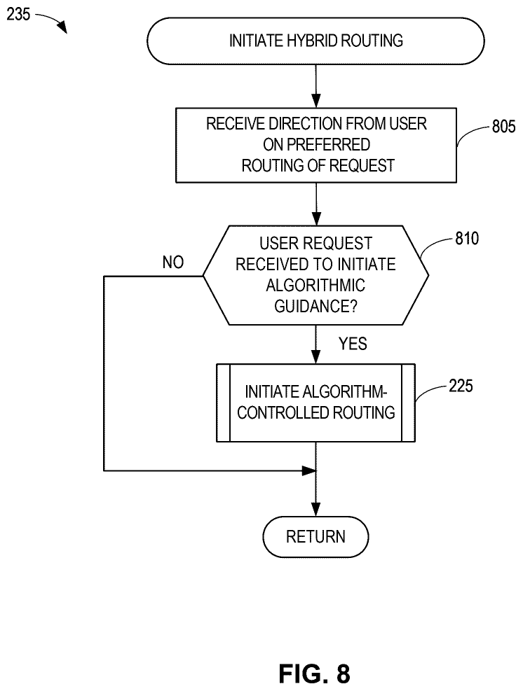

In some examples, the task is performed using manual intervention in combination with algorithmic support, at block 230. In such examples, the routing identifier circuitry 115 initiates hybrid routing, at block 235, as described in more detail in connection with FIG. 8. In examples disclosed herein, hybrid routing is designed for users who have a clear understanding of specific tasks but may require assistance with less familiar tasks, combining user input with algorithmic support. For example, users can make key decisions where they have domain expertise, while leveraging algorithmic guidance for more complex scenarios. In some examples, the task is performed in combination with active user feedback, at block 240. In such examples, the routing identifier circuitry 115 initiates dual path routing with user feedback, at block 245, as described in more detail in connection with FIG. 9. In examples disclosed herein, dual path routing is designed for users who are willing to contribute to continuous improvement through active feedback. If local and remote hardware resources are available, the same query is sent to both sources simultaneously. Users then evaluate and vote on the responses, providing valuable data for refining routing algorithms.

In examples disclosed herein, the routing identifier circuitry 115 can be used to determine routing based on a user query within an enterprise environment. For example, the enterprise environment can include a diverse array of hardware configurations to accommodate various computing needs. In some examples, the enterprise environment can include AI PCs being used as personal working devices (e.g., by the users), edge servers integrated to provide local processing capabilities and enhance performance, workstations shared among small teams for collaborative tasks, and/or additional servers and/or server clusters shared at the departmental and/or corporate level to handle intensive computational loads. Routing user queries within such an environment as described in examples disclosed herein allows for efficient resource allocation and scalability, catering to both individual and collective computing demands within a given organization.

FIG. 3 is a flowchart representative of example machine-readable instructions and/or example operations 225 that may be executed, instantiated, and/or performed by the example task performer circuitry 110 of FIG. 1 to initiate algorithm-controlled routing. The machine-readable instructions and/or the operations 225 of FIG. 3 begin at block 305, at which the routing identifier circuitry 115 receives a user query and identifies the type of task to perform based on the user query, at block 310. For example, the type of task to perform can be based on whether the user query includes user-configured agents and/or user-specified files to use as part of the query. In examples disclosed herein, the routing identifier circuitry 115 determines to perform routing for a Question Answering (QA) task, at block 315, when the user query does not include a specified file to use or a configured agent, proceeding to the QA task routing, at block 400. As described in connection with FIG. 4, the service identifier circuitry 120 determines the availability of local and/or remote (e.g., cloud-based) services for performing the QA task, including identification of whether more than one local and/or remote model is available to perform the task. In examples disclosed herein, the routing identifier circuitry 115 determines to perform routing for a Retrieval Augmented Generation (RAG) task, at block 320, when the user specifies files to use as part of a user query, proceeding to the RAG task routing, at block 500. As described in connection with FIG. 5, the parser circuitry 125 initiates document parsing at a local resource and/or at a remote resource, before the retriever circuitry 130 determines whether to route a user query to a local model or a remote model based on a similarity between locally retrieved context and the user query. In examples disclosed herein, the routing identifier circuitry 115 determines to perform routing for an agent task, at block 325, when user-configured agents are specified, proceeding to the agent task routing, at block 700. As described in connection with FIG. 7, the agent identifier circuitry 135 determines availability of an agent functionality at a local and/or remote service and routes the query to a local and/or remote agent.

FIG. 4 is a flowchart representative of example machine-readable instructions and/or example operations 400 that may be executed, instantiated, and/or performed by the example task performer circuitry 110 of FIG. 1 to perform routing for a question answering (QA) task. The machine-readable instructions and/or the operations 400 of FIG. 4 begin at block 405, at which the service identifier circuitry 120 initiates identification of local and remote GenAI service availability as part of a hierarchical approach to improving resource utilization and efficiency. In examples disclosed herein, local services allow for offline operation using select models based on task requirements, while remote services can represent cloud-based provider services and/or specialized platforms. In some examples, local services require reduced computational resources to execute the task but also result in reduced accuracy, while remote services can require more computational resources to execute the task while providing a higher level of accuracy. If the service identifier circuitry 120 determines that both local and remote services are available, the service identifier circuitry 120 selects between the local and remote services, at block 410. In some examples, the service identifier circuitry 120 selects between local and remote services based on a scope of the required information, a size of the local knowledge database, and/or a system's performance requirements. For example, a question answering task performed using local services can result in a faster response but could potentially have a lower answer accuracy as compared to using a remote service, depending on the complexity of the QA task.

If there is a stronger user preference for accuracy over reduced latency, the service identifier circuitry 120 can determine not to route the task to a local service, at block 415, and instead routes the task to a remote service, at block 420. If the task is routed to a remote service, the service identifier circuitry 120 determines whether more than one remote model is available, at block 435. If only a single remote model is available, then the service identifier circuitry 120 identifies and routes the task to the only remote model, at block 438. However, if the service identifier circuitry 120 that more than one remote model is available, at block 435, the service identifier circuitry 120 routes the task among the remote models, at block 440. However, if the service identifier circuitry 120 initially determines to route the model to a local service, at block 415, the service identifier circuitry 120 determines whether there is more than one local model available to perform the task.

When more than one local model is available, as determined at block 445, the service identifier circuitry 120 proceeds to route the task among the local models, at block 455. Otherwise, the service identifier circuitry 120 proceeds to route the task to the only local model available, at block 450. In some examples, the service identifier circuitry 120 initially determines that both local and remote services are not available, at block 405, and instead identified whether only local services are available, at block 425, or whether only remote services are available, at block 430. When the service identifier circuitry 120 determines that local services are available, at block 425, the same process is followed to identify whether to route the task to one or more local models (blocks 445, 450, 455), as previously described. Conversely, when the service identifier circuitry 120 determines that remote services are available, at block 430, the same process is followed to identify whether to route the task to one or more remote models (blocks 435, 438, 440), as previously described. In examples disclosed herein, local and/or remote QA models can retrieve an answer to a question from a given text and/or generate text directly based on context. As such, the hierarchical routing mechanism of FIG. 4 ensures efficient use of resources and optimal performance based on the available models.

FIG. 5 is a flowchart representative of example machine-readable instructions and/or example operations 500 that may be executed, instantiated, and/or performed by the example task performer circuitry 110 of FIG. 1 to perform routing for a Retrieval-Augmented Generation (RAG) task. The machine-readable instructions and/or the operations 500 of FIG. 5 begin at block 505, at which the parser circuitry 125 initiates document parsing associated with a RAG-based task. RAG is a GenAI framework that improves GenAI by allowing machine learning model engines (e.g., Large Language Models (LLMs), Large Vision Models (LVMs), Large Multimodal Models (LMMs), etc.) to integrate private enterprise data with publicly available information. RAG models allow for the combination of retrieval-based methods with generative models to obtain contextually accurate and semantically rich outputs. RAG can search, query, and/or provision relevant data associated with a user-based query to generate an enriched, contextual prompt that is provided to the machine learning model engine for further processing. RAG-based methods can be classified into vector-based RAG and graph-based RAG. Vector-based RAG calculates semantic similarity between query and document embedding(s), allowing for efficient retrieval of generally related content (e.g., document searches, product recommendations, etc.), while graph-based RAG leverages knowledge graphs, providing more precise contextual information (e.g., for tasks such as question answering, knowledge base completion, etc.).

RAG-based methods can be implemented on computing systems that can support AI-related workloads (e.g., computational tasks involved in developing, training, and/or deploying artificial intelligence models, etc.) requiring significant computational power, memory, and storage (e.g., to support large datasets, complex algorithms, etc.). AI-related workloads can include model training, model inference, data preprocessing, Natural Language Processing (NLP), and/or computer vision. AI-based personal computers (PCs) include hardware features to facilitate efficient AI workload processing, including integrated neural processing units (NPUs), enhanced memory architectures to handle AI model data, optimized instruction sets for AI operations, power management features for AI workloads, and/or hardware-level security features for AI model protection. Such features on AI PCs allow a greater number of AI workloads to run locally on personal computers, reducing the need for cloud processing and improving privacy and latency for AI applications. While an AI PC can be used to implement RAG-based methods, each enterprise can also have an existing server and/or an on-premise cluster that stores data that may be relevant to generating an accurate response to a user query and/or any other GenAI-related task. In particular, large quantities of enterprise data can be stored on the server side and/or other locations (e.g., SharePoint, OneDrive, etc.).

In the example of FIG. 5, the parser circuitry 125 initiates document parsing, which represents a pre-processing step associated with RAG as part of extracting and structuring information from documents to allow a local and/or remote model to use this information to answer questions associated with user queries. For example, modern documents often integrate dense text, complex tables, mathematical expressions, embedded graphics, and/or handwritten annotations, which can be presented in multiple languages and/or formats. This inherent complexity presents unique challenges for processing systems, which must not only accurately detect and recognize individual elements but also reconstruct the underlying structure and semantic relationships that are crucial for downstream applications. In examples disclosed herein, the parser circuitry 125 performs local document processing and/or remote document processing. The routing algorithm for the document parsing phase in RAG is designed to optimize the use of local and/or remote resources based on document location and complexity. The primary objective is to ensure efficient and accurate document processing while reducing resource usage and latency. In the example of FIG. 5, the parser circuitry 125 determines whether a document is present at a local resource, at block 510. If a document is present at the local resource, the parser circuitry 125 determines whether the local document includes non-text content, at block 515. If the parser circuitry 125 determines that the local document contains text only, the parser circuitry 125 initiates basic document parsing at the local resource, at block 520. If the parser circuitry 125 determines that the local document contains both text and non-text content (e.g., embedded graphics, tables, mathematical equations, handwritten annotations, etc.), the parser circuitry 125 proceeds to check the availability of local advanced parsing capabilities, at block 535, or remote advanced parsing capabilities, at block 540. In examples disclosed herein, local advanced parsing is used to process the document, at block 550, unless the parser circuitry 125 determines that no local advanced parsing is available but remote advanced parsing is available, such that the parser circuitry 125 performs that advanced document parsing at the remote resource, at block 555.

However, when the parser circuitry 125 determines that neither local nor remote advanced parsing is available and the parser circuitry 125 determines that the document is not remote, at block 545, the parser circuitry 125 performs basic document parsing at the local resource, at block 520. Likewise, the parser circuitry 125 initiates a similar check for documents located at a remote resource, as identified at block 510. When the parser circuitry 125 identifies non-text content in the remote document, at block 525, the parser circuitry 125 determines whether remote advanced parsing is available, at block 540. If remote advanced parsing is available, the parser circuitry 125 performs advanced document parsing at the remote resource, at block 555. Alternatively, when remote advanced parsing is not available, the parser circuitry 125 proceeds to perform basic document parsing at the remote resource, at block 530. This structured approach ensures that the most appropriate and efficient parsing method is selected based on the specific characteristics of the document and the availability of resources, enhancing overall system performance by leveraging local and remote resources. Subsequently, the parser circuitry 125 determines whether to initiate RAG-based retrieval based on a user query, at block 560. The retriever circuitry 130 initiates RAG-based retrieval, at block 565, as described in more detail in connection with FIG. 6.

FIG. 6 is a flowchart representative of example machine-readable instructions and/or example operations 565 that may be executed, instantiated, and/or performed by the example task performer circuitry 110 of FIG. 1 to perform RAG-based retrieval. The machine-readable instructions and/or the operations 565 of FIG. 6 begin at block 605, at which the retriever circuitry 130 identifies the user query and locally retrieves contextual information, at block 610. In examples disclosed herein, the retrieval phase of RAG includes generating an embedding for the query and calculating a similarity or relevance score between the query and available context. When the retriever circuitry 130 determines that the score of the retrieved context surpasses a predefined threshold, both the query and the most relevant context are directed to the local model for further processing. Conversely, if the score does not meet the threshold, the retriever circuitry 130 directs the query to the Question-Answering (QA) routing pipeline. As shown in the example of FIG. 6, the retriever circuitry 130 determines whether the score of the retrieved context surpasses a predefined threshold, at block 615, and routes the query and context to the local model when the threshold is surpassed, at block 620, or routes the query to the QA routing pipeline described in connection with FIG. 4 when the score falls below the threshold, at block 625. This two-tiered approach ensures efficient and accurate handling of user queries by leveraging both local context and external resources as needed. By combining these strategies, the system can provide more precise and relevant responses, enhancing the overall user experience.

FIG. 7 is a flowchart representative of example machine-readable instructions and/or example operations 700 that may be executed, instantiated, and/or performed by the example task performer circuitry 110 of FIG. 1 to perform routing for an agent task. The machine-readable instructions and/or the operations 700 of FIG. 7 begin at block 705, at which the agent identifier circuitry 135 determines whether a specific AI agent functionality is available at both local and remote services. AI agents transform AI from a reactive tool into a proactive, autonomous, and intelligent partner capable of solving complex problems, managing intricate workflows, and adapting to changing environments. This transformation ultimately drives greater efficiency, accuracy, and innovation. A key component in enabling these capabilities is the Model Context Protocol (MCP), which is widely adopted alongside AI agents due to a structured, standardized, and efficient approach to managing context and interacting with external tools. This protocol ensures seamless communication and integration, allowing agents to operate effectively within both local and remote environments. In examples disclosed herein, the routing algorithm for AI agent tasks is designed to efficiently manage user queries and ensure optimal processing. As part of an initial check, the agent identifier circuitry 135 determines whether the required agent functionality is available both locally and remotely through the MCP server and sends the query to the QA routing pipeline for further decision-making, at block 710. When the agent identifier circuitry 135 determines that the specific agent functionality is not available using both types of services, at block 705, the agent identifier circuitry 135 identifies the availability of either local services, at block 715, or remote services, at block 725, and routes the query to a local agent, at block 720, if the local MCP server has the required functionality, or routes the query to a remote agent, at block 735, if the remote MCP server has the required functionality, respectively. However, when remote services are not available, the agent identifier circuitry 135 routes the user query to a default local model, at block 730. This multi-tiered approach ensures that queries are processed efficiently and accurately, leveraging both local and remote resources to maintain optimal performance and responsiveness.

FIG. 8 is a flowchart representative of example machine-readable instructions and/or example operations 235 that may be executed, instantiated, and/or performed by the example task performer circuitry 110 of FIG. 1 to initiate hybrid routing. The machine-readable instructions and/or the operations 235 of FIG. 8 begin at block 805, at which the routing identifier circuitry 115 receives information from the user on their preferred routing of the user request (e.g., routing to a local model and/or a remote model). In some examples, the user can require additional guidance on the selection of local versus remote services for the processing of a user query, submitting a request to initiate algorithmic guidance, at block 810. The routing identifier circuitry 115 initiates algorithm-controlled routing, at block 225, as described in connection with FIG. 3, to identify the type of task to perform based on the user query (e.g., QA task, RAG task, agent task, etc.).

FIG. 9 is a flowchart representative of example machine-readable instructions and/or example operations 245 that may be executed, instantiated, and/or performed by the example task performer circuitry 110 of FIG. 1 to initiate dual path routing with user feedback. The machine-readable instructions and/or the operations 245 of FIG. 9 begin at block 905, at which the service identifier circuitry 120 determines whether both local and remote services are available. When both services are available, the service identifier circuitry 120 sends the user query to both services simultaneously, at block 910, and the evaluator circuitry 140 identifies output from both services when output from both services is generated based on the user query, at block 915. In examples disclosed herein, the evaluator circuitry 140 prompts the user for evaluation of the generated outputs, at block 920. For example, the user can determine whether the output(s) are accurate and/or whether all information relevant to the query has been received. In examples disclosed here, the evaluator circuitry 140 initiates fine-tuning of routing algorithms based on user feedback scores associated with the output(s) generated using local and remote services, at block 925. For example, to improve the routing algorithms (e.g., routing decisions associated with routing between local and remote sources, routing among local models, and/or routing among remote models, etc.), training can be performed based on user preference data, as this data is most relevant to actual user workflows and provides direct insights into user preferences. However, publicly accessible model preference data can serve as an alternative training source in the absence of user preference data.

In examples disclosed herein, the user feedback data can include the user query, a response generated from a first model, a response generated from a second model, and user-based scoring of the output based on the first model and the second model (e.g., model A score, model B score, etc.). User feedback scores can be leveraged to predict routing using both Large Language Model (LLM)-based and/or non-LLM-based methods. For LLM-based approaches, the evaluator circuitry 140 can input the user's query and instructions into the LLM, which then generates a routing prediction based on this input. Conversely, several non-LLM-based methods can also be employed for generating routing predictions, including transformer-based classifier models, as well as simpler matrix factorization types of recommendation models. These models can be trained to predict routing between local and remote systems, between local models, or between remote models. This dual approach allows for a comprehensive and flexible method of predicting optimal routing paths based on both direct user queries and learned patterns from historical data.

FIG. 10 is a block diagram of an example processing platform 1000 including programmable circuitry structured to execute, instantiate, and/or perform the example machine readable instructions and/or perform the example operations of FIGS. 2-9 to implement the example task performer circuitry 110 of FIG. 1. The programmable circuitry platform 1000 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing and/or electronic device.

The programmable circuitry platform 1000 of the illustrated example includes programmable circuitry 1012. The programmable circuitry 1012 of the illustrated example is hardware. For example, the programmable circuitry 1012 can be implemented by one or more integrated circuits, logic circuits, FPGAs microprocessors, CPUs, GPUs, DSPs, and/or microcontrollers from any desired family or manufacturer. The programmable circuitry 1012 may be implemented by one or more semiconductor based (e.g., silicon based) devices. In this example, the processor circuitry 1012 implements the routing identifier circuitry 115, the service identifier circuitry 120, the parser circuitry 125, the retriever circuitry 130, the agent identifier circuitry 135, the evaluator circuitry 140, and the data storage 145.

The programmable circuitry 1012 of the illustrated example includes a local memory 1013 (e.g., a cache, registers, etc.). The programmable circuitry 1012 of the illustrated example is in communication with a main memory including a volatile memory 1014 and a non-volatile memory 1016 by a bus 1018. The volatile memory 1014 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 1016 may be implemented by flash memory and/or any other desired type of memory device. Access to the main memory 1014, 1016 of the illustrated example is controlled by a memory controller 1017. In some examples, the memory controller 1017 may be implemented by one or more integrated circuits, logic circuits, microcontrollers from any desired family or manufacturer, or any other type of circuitry to manage the flow of data going to and from the main memory 1014, 1016.

The programmable circuitry platform 1000 of the illustrated example also includes interface circuitry 1020. The interface circuitry 1020 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 1022 are connected to the interface circuitry 1020. The input device(s) 1022 permit(s) a user (e.g., a human user, a machine user, etc.) to enter data and/or commands into the programmable circuitry 1012. The input device(s) 1022 can be implemented by, for example, an audio sensor, a microphone, a camera (still or video), a keyboard, a button, a mouse, a touchscreen, a track-pad, a trackball, an isopoint device, and/or a voice recognition system.

One or more output devices 1024 are also connected to the interface circuitry 1020 of the illustrated example. The output devices 1024 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 1020 of the illustrated example, thus, typically includes a graphics driver card, a graphics driver chip, and/or graphics processor circuitry such as a GPU.

The interface circuitry 1020 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 1026. The communication can be by, for example, an Ethernet connection, a digital subscriber line (DSL) connection, a telephone line connection, a coaxial cable system, a satellite system, a line-of-site wireless system, a cellular telephone system, an optical connection, etc.

The programmable circuitry platform 1000 of the illustrated example also includes one or more mass storage devices 1028 to store software and/or data. Examples of such mass storage devices 1028 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine executable instructions 1032, which may be implemented by the machine readable instructions of FIGS. 2-9, may be stored in the mass storage device 1028, in the volatile memory 1014, in the non-volatile memory 1016, and/or on at least one non-transitory computer readable storage medium such as a CD or DVD which may be removable.

FIG. 11 is a block diagram of an example implementation of the programmable circuitry 1012 of FIG. 10. In this example, the programmable circuitry 1012 of FIG. 10 is implemented by a microprocessor 1100. For example, the microprocessor 1100 may be a general purpose microprocessor (e.g., general purpose microprocessor circuitry). The microprocessor 1100 executes some or all of the machine readable instructions of the flowcharts of FIGS. 2-9 to effectively instantiate the circuitry of FIG. 1 logic circuits to perform the operations corresponding to those machine readable instructions. In some such examples, the circuitry of FIG. 1 is instantiated by the hardware circuits of the microprocessor 1100 in combination with the instructions. For example, the microprocessor 1100 may implement multi-core hardware circuitry such as a CPU, a DSP, a GPU, an XPU, etc. Although it may include any number of example cores 1102 (e.g., 1 core), the microprocessor 1100 of this example is a multi-core semiconductor device including N cores. The cores 1102 of the microprocessor 1100 may operate independently or may cooperate to execute machine readable instructions. For example, machine code corresponding to a firmware program, an embedded software program, or a software program may be executed by one of the cores 1102 or may be executed by multiple ones of the cores 1102 at the same or different times. In some examples, the machine code corresponding to the firmware program, the embedded software program, or the software program is split into threads and executed in parallel by two or more of the cores 1102. The software program may correspond to a portion or all of the machine readable instructions and/or operations represented by the flowcharts of FIGS. 2-9.

The cores 1102 may communicate by a first example bus 1104. In some examples, the first bus 1104 may implement a communication bus to effectuate communication associated with one(s) of the cores 1102. For example, the first bus 1104 may implement at least one of an Inter-Integrated Circuit (I2C) bus, a Serial Peripheral Interface (SPI) bus, a PCI bus, or a PCIe bus. Additionally or alternatively, the first bus 1104 may implement any other type of computing or electrical bus. The cores 1102 may obtain data, instructions, and/or signals from one or more external devices by example interface circuitry 1106. The cores 1102 may output data, instructions, and/or signals to the one or more external devices by the interface circuitry 1106. Although the cores 1102 of this example include example local memory 1120 (e.g., Level 1 (L1) cache that may be split into an L1 data cache and an L1 instruction cache), the microprocessor 1100 also includes example shared memory 1110 that may be shared by the cores (e.g., Level 2 (L2_cache)) for high-speed access to data and/or instructions. Data and/or instructions may be transferred (e.g., shared) by writing to and/or reading from the shared memory 1110. The local memory 1120 of each of the cores 1102 and the shared memory 1110 may be part of a hierarchy of storage devices including multiple levels of cache memory and the main memory (e.g., the main memory 1014, 1016 of FIG. 10). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 1102 may be referred to as a CPU, DSP, GPU, etc., or any other type of hardware circuitry. Each core 1102 includes control unit circuitry 1114, arithmetic and logic (AL) circuitry (sometimes referred to as an ALU) 1116, a plurality of registers 1118, the L1 cache 1120, and a second example bus 1122. Other structures may be present. For example, each core 1102 may include vector unit circuitry, single instruction multiple data (SIMD) unit circuitry, load/store unit (LSU) circuitry, branch/jump unit circuitry, floating-point unit (FPU) circuitry, etc. The control unit circuitry 1114 includes semiconductor-based circuits structured to control (e.g., coordinate) data movement within the corresponding core 1102. The AL circuitry 1116 includes semiconductor-based circuits structured to perform one or more mathematic and/or logic operations on the data within the corresponding core 1102. The AL circuitry 1116 of some examples performs integer-based operations. In other examples, the AL circuitry 1116 also performs floating-point operations. In yet other examples, the AL circuitry 1116 may include first AL circuitry that performs integer-based operations and second AL circuitry that performs floating point operations. In some examples, the AL circuitry 1116 may be referred to as an Arithmetic Logic Unit (ALU).

The registers 1118 are semiconductor-based structures to store data and/or instructions such as results of one or more of the operations performed by the AL circuitry 1116 of the corresponding core 1102. For example, the registers 1118 may include vector register(s), SIMD register(s), general purpose register(s), flag register(s), segment register(s), machine specific register(s), instruction pointer register(s), control register(s), debug register(s), memory management register(s), machine check register(s), etc. The registers 1118 may be arranged in a bank as shown in FIG. 11. Alternatively, the registers 1118 may be organized in any other arrangement, format, or structure including distributed throughout the core 1102 to shorten access time. The second bus 1122 may be implemented by at least one of an I2C bus, a SPI bus, a PCI bus, or a PCIe bus.

Each core 1102 and/or, more generally, the microprocessor 1100 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 1100 is a semiconductor device fabricated to include many transistors interconnected to implement the structures described above in one or more integrated circuits (ICs) contained in one or more packages.

The microprocessor 1100 may include and/or cooperate with one or more accelerators (e.g., acceleration circuitry, hardware accelerators, etc.). In some examples, accelerators are implemented by logic circuitry to perform certain tasks more quickly and/or efficiently than can be done by a general-purpose processor. Examples of accelerators include ASICs and FPGAs such as those discussed herein. A GPU, DSP and/or other programmable device can also be an accelerator. Accelerators may be on-board the microprocessor 1100, in the same chip package as the microprocessor 1100 and/or in one or more separate packages from the microprocessor 1100.

FIG. 12 is a block diagram of another example implementation of the programmable circuitry of FIG. 10. In this example, the programmable circuitry 1012 is implemented by FPGA circuitry 1200. For example, the FPGA circuitry 1200 may be implemented by an FPGA. The FPGA circuitry 1200 can be used, for example, to perform operations that could otherwise be performed by the example microprocessor 1200 of FIG. 12 executing corresponding machine readable instructions. However, once configured, the FPGA circuitry 1200 instantiates the operations and/or functions corresponding to the machine readable instructions in hardware and, thus, can often execute the operations/functions faster than they could be performed by a general-purpose microprocessor executing the corresponding software.

More specifically, in contrast to the microprocessor 1100 of FIG. 11 described above (which is a general purpose device that may be programmed to execute some or all of the machine readable instructions represented by the flowcharts of FIGS. 2-9 but whose interconnections and logic circuitry are fixed once fabricated), the FPGA circuitry 1200 of the example of FIG. 12 includes interconnections and logic circuitry that may be configured, structured, programmed, and/or interconnected in different ways after fabrication to instantiate, for example, some or all of the operations/functions corresponding to the machine readable instructions represented by the flowcharts of FIGS. 2-9. In particular, the FPGA 1200 may be thought of as an array of logic gates, interconnections, and switches. The switches can be programmed to change how the logic gates are interconnected by the interconnections, effectively forming one or more dedicated logic circuits (unless and until the FPGA circuitry 1200 is reprogrammed). The configured logic circuits enable the logic gates to cooperate in different ways to perform different operations on data received by input circuitry. Those operations may correspond to some or all of the instructions (e.g., the software and/or firmware) represented by the flowcharts of FIGS. 2-9. As such, the FPGA circuitry 1200 may be configured and/or structured to effectively instantiate some or all of the operations/functions corresponding to the machine readable instructions of the flowcharts of FIGS. 2-9 as dedicated logic circuits to perform the operations/functions corresponding to those software instructions in a dedicated manner analogous to an ASIC. Therefore, the FPGA circuitry 1200 may perform the operations/functions corresponding to the some or all of the machine readable instructions of FIGS. 2-9 faster than the general-purpose microprocessor can execute the same.

In the example of FIG. 12, the FPGA circuitry 1200 is configured and/or structured in response to being programmed (and/or reprogrammed one or more times) based on a binary file. In some examples, the binary file may be compiled and/or generated based on instructions in a hardware description language (HDL) such as Lucid, Very High Speed Integrated Circuits (VHSIC) Hardware Description Language (VHDL), or Verilog. For example, a user (e.g., a human user, a machine user, etc.) may write code or a program corresponding to one or more operations/functions in an HDL; the code/program may be translated into a low-level language as needed; and the code/program (e.g., the code/program in the low-level language) may be converted (e.g., by a compiler, a software application, etc.) into the binary file. In some examples, the FPGA circuitry 1200 of FIG. 12 may access and/or load the binary file to cause the FPGA circuitry 1200 of FIG. 12 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1200 of FIG. 12 to cause configuration and/or structuring of the FPGA circuitry 1200 of FIG. 12, or portion(s) thereof.

In some examples, the binary file is compiled, generated, transformed, and/or otherwise output from a uniform software platform utilized to program FPGAs. For example, the uniform software platform may translate first instructions (e.g., code or a program) that correspond to one or more operations/functions in a high-level language (e.g., C, C++, Python, etc.) into second instructions that correspond to the one or more operations/functions in an HDL. In some such examples, the binary file is compiled, generated, and/or otherwise output from the uniform software platform based on the second instructions. In some examples, the FPGA circuitry 1200 of FIG. 12 may access and/or load the binary file to cause the FPGA circuitry 1200 of FIG. 12 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1200 of FIG. 12 to cause configuration and/or structuring of the FPGA circuitry 1200 of FIG. 12, or portion(s) thereof.

The FPGA circuitry 1200 of FIG. 12, includes example input/output (I/O) circuitry 1202 to obtain and/or output data to/from example configuration circuitry 1204 and/or external hardware 1206. For example, the configuration circuitry 1204 may be implemented by interface circuitry that may obtain a binary file, which may be implemented by a bit stream, data, and/or machine-readable instructions, to configure the FPGA circuitry 1200, or portion(s) thereof. In some such examples, the configuration circuitry 1204 may obtain the binary file from a user, a machine (e.g., hardware circuitry (e.g., programmable or dedicated circuitry) that may implement an Artificial Intelligence/Machine Learning (AI/ML) model to generate the binary file), etc., and/or any combination(s) thereof). In some examples, the external hardware 1206 may be implemented by external hardware circuitry. For example, the external hardware 1206 may be implemented by the microprocessor 1100 of FIG. 11.

The FPGA circuitry 1200 also includes an array of example logic gate circuitry 1208, a plurality of example configurable interconnections 1210, and example storage circuitry 1212. The logic gate circuitry 1208 and the configurable interconnections 1210 are configurable to instantiate one or more operations/functions that may correspond to at least some of the machine readable instructions of FIGS. 2-9 and/or other desired operations. The logic gate circuitry 1208 shown in FIG. 12 is fabricated in blocks or groups. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 1208 to enable configuration of the electrical structures and/or the logic gates to form circuits to perform desired operations/functions. The logic gate circuitry 1208 may include other electrical structures such as look-up tables (LUTs), registers (e.g., flip-flops or latches), multiplexers, etc.

The configurable interconnections 1210 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 1208 to program desired logic circuits.

The storage circuitry 1212 of the illustrated example is structured to store result(s) of the one or more of the operations performed by corresponding logic gates. The storage circuitry 1212 may be implemented by registers or the like. In the illustrated example, the storage circuitry 1212 is distributed amongst the logic gate circuitry 1208 to facilitate access and increase execution speed.

The example FPGA circuitry 1200 of FIG. 12 also includes example dedicated operations circuitry 1214. In this example, the dedicated operations circuitry 1214 includes special purpose circuitry 1216 that may be invoked to implement commonly used functions to avoid the need to program those functions in the field. Examples of such special purpose circuitry 1216 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 1200 may also include example general purpose programmable circuitry 1218 such as an example CPU 1220 and/or an example DSP 1222. Other general purpose programmable circuitry 1218 may additionally or alternatively be present such as a GPU, an XPU, etc., that can be programmed to perform other operations.

Although FIGS. 11 and 12 illustrate two example implementations of the programmable circuitry 1012 of FIG. 10, many other approaches are contemplated. For example, FPGA circuitry may include an on-board CPU, such as one or more of the example CPU 1220 of FIG. 12. Therefore, the programmable circuitry 1012 of FIG. 10 may additionally be implemented by combining at least the example microprocessor 1100 of FIG. 11 and the example FPGA circuitry 1200 of FIG. 12. In some such hybrid examples, one or more cores 1202 of FIG. 12 may execute a first portion of the machine readable instructions represented by the flowchart(s) of FIGS. 2-9 to perform first operation(s)/function(s), the FPGA circuitry 1200 of FIG. 12 may be configured and/or structured to perform second operation(s)/function(s) corresponding to a second portion of the machine readable instructions represented by the flowcharts of FIGS. 2-9, and/or an ASIC may be configured and/or structured to perform third operation(s)/function(s) corresponding to a third portion of the machine readable instructions represented by the flowcharts of FIGS. 2-9.

It should be understood that some or all of the circuitry of FIG. 1 may, thus, be instantiated at the same or different times. For example, same and/or different portion(s) of the microprocessor 1100 of FIG. 11 may be programmed to execute portion(s) of machine-readable instructions at the same and/or different times. In some examples, same and/or different portion(s) of the FPGA circuitry 1200 of FIG. 12 may be configured and/or structured to perform operations/functions corresponding to portion(s) of machine-readable instructions at the same and/or different times.

In some examples, some or all of the circuitry of FIG. 1 may be instantiated, for example, in one or more threads executing concurrently and/or in series. For example, the microprocessor 1100 of FIG. 11 may execute machine readable instructions in one or more threads executing concurrently and/or in series. In some examples, the FPGA circuitry 1200 of FIG. 12 may be configured and/or structured to carry out operations/functions concurrently and/or in series. Moreover, in some examples, some or all of the circuitry of FIG. 1 may be implemented within one or more virtual machines and/or containers executing on the microprocessor 1100 of FIG. 11.

In some examples, the programmable circuitry 1012 of FIG. 10 may be in one or more packages. For example, the microprocessor 1100 of FIG. 11 and/or the FPGA circuitry 1200 of FIG. 12 may be in one or more packages. In some examples, an XPU may be implemented by the programmable circuitry 1012 of FIG. 10 which may be in one or more packages. For example, the XPU may include a CPU (e.g., the microprocessor 1100 of FIG. 11, the CPU 1220 of FIG. 12, etc.) in one package, a DSP (e.g., the DSP 1222 of FIG. 12) in another package, a GPU in yet another package, and an FPGA (e.g., the FPGA circuitry 1200 of FIG. 12) in still yet another package.

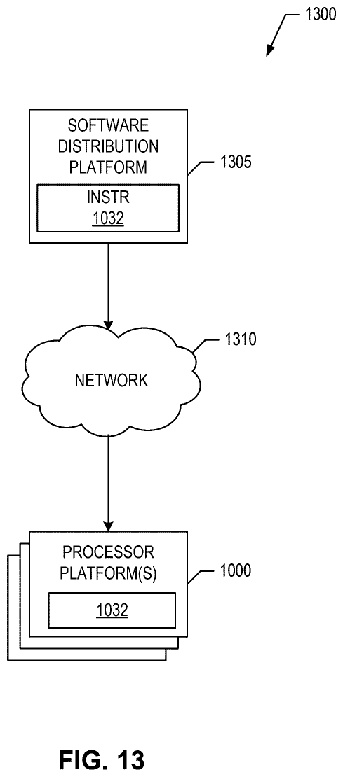

A block diagram illustrating an example software distribution platform 1305 to distribute software such as the example machine readable instructions 1032 of FIG. 10 to other hardware devices (e.g., hardware devices owned and/or operated by third parties from the owner and/or operator of the software distribution platform) is illustrated in FIG. 13. The example software distribution platform 1305 may be implemented by any computer server, data facility, cloud service, etc., capable of storing and transmitting software to other computing devices. The third parties may be customers of the entity owning and/or operating the software distribution platform 1305. For example, the entity that owns and/or operates the software distribution platform 1305 may be a developer, a seller, and/or a licensor of software such as the example machine readable instructions 1032 of FIG. 10. The third parties may be consumers, users, retailers, OEMs, etc., who purchase and/or license the software for use and/or re-sale and/or sub-licensing. In the illustrated example, the software distribution platform 1005 includes one or more servers and one or more storage devices. The storage devices store the machine readable instructions 1032, which may correspond to the example machine readable instructions of FIGS. 2-9, as described above. The one or more servers of the example software distribution platform 1305 are in communication with an example network 1310, which may correspond to any one or more of the Internet and/or any of the example networks described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine readable instructions 1032 from the software distribution platform 1305. For example, the software, which may correspond to the example machine readable instructions of FIGS. 2-9, may be downloaded to the example programmable circuitry platform 1000, which is to execute the machine readable instructions 1032 to implement the task performer circuitry 110 of FIG. 1. In some examples, one or more servers of the software distribution platform 1305 periodically offer, transmit, and/or force updates to the software (e.g., the example machine readable instructions 1032 of FIG. 10) to ensure improvements, patches, updates, etc., are distributed and applied to the software at the end user devices. Although referred to as software above, the distributed “software” could alternatively be firmware.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein integrated circuit/circuitry is defined as one or more semiconductor packages containing one or more circuit elements such as transistors, capacitors, inductors, resistors, current paths, diodes, etc. For example, an integrated circuit may be implemented as one or more of an ASIC, an FPGA, a chip, a microchip, programmable circuitry, a semiconductor substrate coupling multiple circuit elements, a system on chip (SoC), etc.

From the foregoing, it will be appreciated that example systems, methods, apparatus, and articles of manufacture disclosed herein efficiently distribute GenAI tasks to different enterprise hardware for improved accuracy of task execution while reducing a total cost of ownership. Methods and apparatus disclosed herein route GenAI tasks to different local and/or remote hardware resources for efficient resource allocation and scalability, catering to both individual and collective computing demands within an organization. In examples disclosed herein, GenAI task routing can be user-controlled, algorithm-controlled, hybrid, and/or dual path with user feedback. Additionally, algorithm-controlled routing can include routing for Question Answering (QA) tasks, routing for Retrieval Augmented Generation (RAG) tasks, and/or routing for agent tasks. In examples disclosed herein, performing RAG-based retrieval includes determining whether a similarity score between the user query and locally retrieved contextual information exceeds a given threshold as part of identifying whether to route the user query and context to a local model or to a QA routing pipeline. In examples disclosed herein, performing routing for an agent task includes identifying whether to route a request to a local or remote agent based on availability. Additionally, fine-tuning of routing algorithms is performed based on user feedback evaluating output from remote and local services. Thus, examples disclosed herein result in improvements to the operation of a machine.

Example methods, apparatus, systems, and articles of manufacture for distributing GenAI tasks to different enterprise hardware are disclosed herein. Further examples and combinations thereof include the following:

Example 1 includes an apparatus, comprising interface circuitry, machine-readable instructions, and at least one processor circuit to be programmed by the machine-readable instructions to identify availability of a local hardware resource or a remote hardware resource for a routing request associated with a generative artificial intelligence (GenAI) task, route the GenAI task to a local model of the local hardware resource when a score of a retrieved context from the local hardware resource surpasses a threshold, and cause generation of an output of the GenAI task based on the local model.

Example 2 includes the apparatus as defined in example 1, wherein one or more of the at least one processor circuit is to determine the score of the retrieved context based on a similarity between a user query associated with the GenAI task and the retrieved context.

Example 3 includes the apparatus as defined in one or more of examples 1-2, wherein one or more of the at least one processor circuit is to perform a question answering (QA) task routing when the score of the retrieved context is below the threshold, the QA task routing to route the user query among one or more local models or one or more remote models.

Example 4 includes the apparatus as defined in one or more of examples 1-3, wherein one or more of the at least one processor circuit is to identify a routing pathway based on the availability of the local hardware resource or the remote hardware resource, the routing pathway including at least one of a user-controlled routing, an algorithm-controlled routing, a hybrid routing, and a dual path routing.

Example 5 includes the apparatus as defined in one or more of examples 1-4, wherein the algorithm-controlled routing includes at least one of a QA task routing, a Retrieval-Augmented Generation (RAG) task routing, and an agent task routing.

Example 6 includes the apparatus as defined in one or more of examples 1-5, wherein the dual path routing includes generating a user feedback score for finetuning of a routing algorithm using a Large Language Model (LLM).

Example 7 includes the apparatus as defined in one or more of examples 1-6, wherein the RAG task routing includes selection of the local hardware resource or the remote hardware resource based on at least one of a document complexity or location.

Example 8 includes the apparatus as defined in one or more of examples 1-7, wherein the agent task routing includes identifying an agent functionality at the local hardware resource or the remote hardware resource through a Model Context Protocol (MCP) server to determine whether to direct a user query associated with the GenAI task to a local agent, a remote agent, or the QA task routing.

Example 9 includes at least one non-transitory machine-readable medium comprising machine-readable instructions to cause at least one processor circuit to at least identify availability of a local hardware resource or a remote hardware resource for a routing request associated with a generative artificial intelligence (GenAI) task, route the GenAI task to a local model of the local hardware resource when a score of a retrieved context from the local hardware resource surpasses a threshold, and cause generation of an output of the GenAI task based on the local model.

Example 10 includes the at least one non-transitory machine-readable medium as defined in example 9, wherein the machine-readable instructions are to cause one or more of the at least one processor circuit to determine the score of the retrieved context based on a similarity between a user query associated with the GenAI task and the retrieved context.

Example 11 includes the at least one non-transitory machine-readable medium as defined in one or more of examples 9-10, wherein the machine-readable instructions are to cause one or more of the at least one processor circuit to perform a question answering (QA) task routing when the score of the retrieved context is below the threshold, the QA task routing to route the user query among one or more local models or one or more remote models.

Example 12 includes the at least one non-transitory machine-readable medium as defined in one or more of examples 9-11, wherein the machine-readable instructions are to cause one or more of the at least one processor circuit to identify a routing pathway based on the availability of the local hardware resource or the remote hardware resource, the routing pathway including at least one of a user-controlled routing, an algorithm-controlled routing, a hybrid routing, and a dual path routing.

Example 13 includes the at least one non-transitory machine-readable medium as defined in one or more of examples 9-12, wherein the algorithm-controlled routing includes at least one of a QA task routing, a Retrieval-Augmented Generation (RAG) task routing, and an agent task routing.

Example 14 includes the at least one non-transitory machine-readable medium as defined in one or more of examples 9-13, wherein the dual path routing includes generating a user feedback score for finetuning of a routing algorithm using a Large Language Model (LLM).

Example 15 includes the at least one non-transitory machine-readable medium as defined in one or more of examples 9-14, wherein the RAG task routing includes selection of the local hardware resource or the remote hardware resource based on at least one of a document complexity or location.

Example 16 includes the at least one non-transitory machine-readable medium as defined in one or more of examples 9-15, wherein the agent task routing includes identifying an agent functionality at the local hardware resource or the remote hardware resource through a Model Context Protocol (MCP) server to determine whether to direct a user query associated with the GenAI task to a local agent, a remote agent, or the QA task routing.

Example 17 includes an apparatus, comprising means for identifying availability of a local hardware resource or a remote hardware resource for a routing request associated with a generative artificial intelligence (GenAI) task, means for routing the GenAI task to a local model of the local hardware resource when a score of a retrieved context from the local hardware resource surpasses a threshold, and means for causing generation of an output of the GenAI task based on the local model.

Example 18 includes the apparatus as defined in example 17, wherein the means for routing the GenAI task is to determine the score of the retrieved context based on a similarity between a user query associated with the GenAI task and the retrieved context.

Example 19 includes the apparatus as defined in one or more of examples 17-18, wherein the means for routing the GenAI task is to perform a question answering (QA) task routing when the score of the retrieved context is below the threshold, the QA task routing to route the user query among one or more local models or one or more remote models.

Example 20 includes the apparatus as defined in one or more of examples 17-19, wherein the means for identifying availability is to identify a routing pathway based on the availability of the local hardware resource or the remote hardware resource, the routing pathway including at least one of a user-controlled routing, an algorithm-controlled routing, a hybrid routing, and a dual path routing.

Example 21 includes the apparatus as defined in one or more of examples 17-20, wherein the algorithm-controlled routing includes at least one of a QA task routing, a Retrieval-Augmented Generation (RAG) task routing, and an agent task routing.

Example 22 includes the apparatus as defined in one or more of examples 17-21, wherein the dual path routing includes generating a user feedback score for finetuning of a routing algorithm using a Large Language Model (LLM).

Example 23 includes the apparatus as defined in one or more of examples 17-22, wherein the RAG task routing includes selection of the local hardware resource or the remote hardware resource based on at least one of a document complexity or location.

Example 24 includes the apparatus as defined in one or more of examples 17-23, wherein the agent task routing includes identifying an agent functionality at the local hardware resource or the remote hardware resource through a Model Context Protocol (MCP) server to determine whether to direct a user query associated with the GenAI task to a local agent, a remote agent, or the QA task routing.

Example 25 includes a method, comprising identifying availability of a local hardware resource or a remote hardware resource for a routing request associated with a generative artificial intelligence (GenAI) task, routing the GenAI task to a local model of the local hardware resource when a score of a retrieved context from the local hardware resource surpasses a threshold, and causing generation of an output of the GenAI task based on the local model.

Example 26 includes the method as defined in example 25, further including determining the score of the retrieved context based on a similarity between a user query associated with the GenAI task and the retrieved context.

Example 27 includes the method as defined in one or more of examples 25-26, further including performing a question answering (QA) task routing when the score of the retrieved context is below the threshold, the QA task routing to route the user query among one or more local models or one or more remote models.

Example 28 includes the method as defined in one or more of examples 25-27, further including identifying a routing pathway based on the availability of the local hardware resource or the remote hardware resource, the routing pathway including at least one of a user-controlled routing, an algorithm-controlled routing, a hybrid routing, and a dual path routing.

Example 29 includes the method as defined in one or more of examples 25-28, wherein the algorithm-controlled routing includes at least one of a QA task routing, a Retrieval-Augmented Generation (RAG) task routing, and an agent task routing.

Example 30 includes the method as defined in one or more of examples 25-29, wherein the dual path routing includes generating a user feedback score for finetuning of a routing algorithm using a Large Language Model (LLM).

Example 31 includes the method as defined in one or more of examples 25-30, wherein the RAG task routing includes selection of the local hardware resource or the remote hardware resource based on at least one of a document complexity or location.

Example 32 includes the method as defined in one or more of examples 25-31, wherein the agent task routing includes identifying an agent functionality at the local hardware resource or the remote hardware resource through a Model Context Protocol (MCP) server to determine whether to direct a user query associated with the GenAI task to a local agent, a remote agent, or the QA task routing.

The following claims are hereby incorporated into this Detailed Description by this reference. Although certain example systems, methods, apparatus, and articles of manufacture have been disclosed herein, the scope of coverage of this patent is not limited thereto. On the contrary, this patent covers all systems, methods, apparatus, and articles of manufacture fairly falling within the scope of the claims of this patent.

1. An apparatus, comprising:
interface circuitry;
machine-readable instructions; and
at least one processor circuit to be programmed by the machine-readable instructions to:
identify availability of a local hardware resource or a remote hardware resource for a routing request associated with a generative artificial intelligence (GenAI) task;
route the GenAI task to a local model of the local hardware resource when a score of a retrieved context from the local hardware resource surpasses a threshold; and
cause generation of an output of the GenAI task based on the local model.

2. The apparatus of claim 1, wherein one or more of the at least one processor circuit is to determine the score of the retrieved context based on a similarity between a user query associated with the GenAI task and the retrieved context.

3. The apparatus of claim 2, wherein one or more of the at least one processor circuit is to perform a question answering (QA) task routing when the score of the retrieved context is below the threshold, the QA task routing to route the user query among one or more local models or one or more remote models.

4. The apparatus of claim 1, wherein one or more of the at least one processor circuit is to identify a routing pathway based on the availability of the local hardware resource or the remote hardware resource, the routing pathway including at least one of a user-controlled routing, an algorithm-controlled routing, a hybrid routing, and a dual path routing.

5. The apparatus of claim 4, wherein the algorithm-controlled routing includes at least one of a QA task routing, a Retrieval-Augmented Generation (RAG) task routing, and an agent task routing.

6. The apparatus of claim 4, wherein the dual path routing includes generating a user feedback score for finetuning of a routing algorithm using a Large Language Model (LLM).

7. The apparatus of claim 5, wherein the RAG task routing includes selection of the local hardware resource or the remote hardware resource based on at least one of a document complexity or location.

8. The apparatus of claim 5, wherein the agent task routing includes identifying an agent functionality at the local hardware resource or the remote hardware resource through a Model Context Protocol (MCP) server to determine whether to direct a user query associated with the GenAI task to a local agent, a remote agent, or the QA task routing.

9. At least one non-transitory machine-readable medium comprising machine-readable instructions to cause at least one processor circuit to at least:
identify availability of a local hardware resource or a remote hardware resource for a routing request associated with a generative artificial intelligence (GenAI) task;
route the GenAI task to a local model of the local hardware resource when a score of a retrieved context from the local hardware resource surpasses a threshold; and
cause generation of an output of the GenAI task based on the local model.

10. The at least one non-transitory machine-readable medium of claim 9, wherein the machine-readable instructions are to cause one or more of the at least one processor circuit to determine the score of the retrieved context based on a similarity between a user query associated with the GenAI task and the retrieved context.

11. The at least one non-transitory machine-readable medium of claim 10, wherein the machine-readable instructions are to cause one or more of the at least one processor circuit to perform a question answering (QA) task routing when the score of the retrieved context is below the threshold, the QA task routing to route the user query among one or more local models or one or more remote models.

12. The at least one non-transitory machine-readable medium of claim 9, wherein the machine-readable instructions are to cause one or more of the at least one processor circuit to identify a routing pathway based on the availability of the local hardware resource or the remote hardware resource, the routing pathway including at least one of a user-controlled routing, an algorithm-controlled routing, a hybrid routing, and a dual path routing.

13. The at least one non-transitory machine-readable medium of claim 12, wherein the algorithm-controlled routing includes at least one of a QA task routing, a Retrieval-Augmented Generation (RAG) task routing, and an agent task routing.

14. The at least one non-transitory machine-readable medium of claim 12, wherein the dual path routing includes generating a user feedback score for finetuning of a routing algorithm using a Large Language Model (LLM).

15. The at least one non-transitory machine-readable medium of claim 13, wherein the RAG task routing includes selection of the local hardware resource or the remote hardware resource based on at least one of a document complexity or location.

16. The at least one non-transitory machine-readable medium of claim 13, wherein the agent task routing includes identifying an agent functionality at the local hardware resource or the remote hardware resource through a Model Context Protocol (MCP) server to determine whether to direct a user query associated with the GenAI task to a local agent, a remote agent, or the QA task routing.

17. An apparatus, comprising:
means for identifying availability of a local hardware resource or a remote hardware resource for a routing request associated with a generative artificial intelligence (GenAI) task;
means for routing the GenAI task to a local model of the local hardware resource when a score of a retrieved context from the local hardware resource surpasses a threshold; and
means for causing generation of an output of the GenAI task based on the local model.

18. The apparatus of claim 17, wherein the means for routing the GenAI task is to determine the score of the retrieved context based on a similarity between a user query associated with the GenAI task and the retrieved context.

19. The apparatus of claim 18, wherein the means for routing the GenAI task is to perform a question answering (QA) task routing when the score of the retrieved context is below the threshold, the QA task routing to route the user query among one or more local models or one or more remote models.

20. The apparatus of claim 17, wherein the means for identifying availability is to identify a routing pathway based on the availability of the local hardware resource or the remote hardware resource, the routing pathway including at least one of a user-controlled routing, an algorithm-controlled routing, a hybrid routing, and a dual path routing.
